(19) United States
(12) Patent Application Publication
(10) Pub. No.: US 2008/0154911 A1
(43) Pub. Date: Jun. 26, 2008

(54) SYSTEM AND METHOD FOR ON-LINE GENERATION OF ASIAN DOCUMENTS WITH MULTIPLE FONT FACES

(75) Inventor: Kuo-Young Cheng, Taichung Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: DynaComware Taiwan Inc., Taipei (TW)

(21) Appl. No.: 11/627,600

(22) Filed: Jan. 26, 2007

(30) Foreign Application Priority Data
Dec. 26, 2006 (JP) 2006-350474

(51) Int. Cl. G06F 17/30; G06F 15/00; G06F 7/00

(52) U.S. Cl. 707/10

(57) ABSTRACT

A network-based method is provided for generating or editing an Asian document with multiple font faces, wherein the multiple font faces that are not registered in a client computer are supplied by a Web font center. The method includes generally three steps. First, a Web font center is provided and connected to a Web site system for Asian Web page document publishing. Second, communication is established between the Web font center and the Web site for transmitting font related information therebetween. Third, a client computer of the Web site is allowed to make, edit, and view an Asian Web page document with multiple font faces, some of which may not be registered in the client computer.

### FIELD OF THE INVENTION

The present invention relates to the art of Asian character processing and, more particularly, to a system and method for generating and editing Asian character documents including multiple font faces.

### BACKGROUND

The use of Internet browsers is widespread for viewing electronic documents posted on Web sites. Typically, a client computer user accesses Web information by directly entering a URL (Uniform Resource Locator) of a desired Web page into the browser, or by using a search engine to locate several Web pages of interest and selecting one of them, or by moving and clicking a mouse on a hyperlink to the URL displayed on a computer screen. The browser will then download a Web page from the specified URL and display the Web page on the computer screen.

With the advent of computer network technology, Internet browser software operating on a personal computer allows a user to not only view Web pages posted on a Web site but also to publish a personal document on a Web site for others to read. For example, in the application of BLOG, a blogger creates a Web page document to be posted on a Web site for other bloggers to read and respond to, thereby interactively creating more Web page documents published in the community of bloggers. Typically, Internet browser software installed in a client computer executes a user-interface screen display program provided by a Web site, which allows a user to make, edit, and view Web page documents.

However, browser software can support and display a particular standard font face (or font, which is defined by specific visual characteristics of characters and symbols such as the width or curve of strokes that form a character) only if that font face is registered or installed in the client computer or, in the case of a user-defined (non-standard) font face, only if the user-defined font face can be rendered directly by the font engine installed in the client computer. While many standard font faces are registered in many client computers, other non-standard and unique font faces (such as some user-defined font face characters/symbols) are not. Also, the font faces that are registered at different client computers vary widely. Thus, if a particular font face specified in a Web page document is not supported by a client computer receiving the Web page document, the computer cannot display the document with the original font face. Also, in on-line publishing systems (e.g., blogs) where browser software is used to make, view, and edit documents distributed among users, the appearance of a document viewed by two users may be different if their computers have different font faces registered thereon. Clearly, this is undesirable because the bloggers cannot share the same appearance of a document.

Typically, there are two methods by which browser software (or reader software) displays characters. The first one is by receiving character codes (JIS code, Unicode, etc.) and sending them to the client computer to access the font data corresponding to the character codes so that the computer's font engine can then render the font data to display the characters on a computer screen. The second one is by receiving the characters' font data themselves and sending them directly to the computer's font engine to render the font data to display the characters. The first method is typical for displaying the font face characters that are registered in the computer, i.e., displaying the “system” font face characters. The second method is used to display user-defined font face characters, or “non-system” (or “non-standard”) font face characters.

Most existing on-line document publishing systems support only system font face characters. When a client computer does not support a font face designated in a Web page document, the browser or reader software operating thereon selects a default font face and replaces the designated font face with the default font face. This is undesirable as it causes the appearance of a published document to differ from what was intended by its author. This problem is more serious with Asian languages than in Roman-based languages because there are more variations and types of font faces in Asian languages than in Roman-based languages. In Web application of an Asian document publishing system, for example, very often a Web page author wants to create a Web page document with some special non-standard font face characters to express or emphasize some semantic connotation of words or phrases in the document. Current on-line Asian document publishing systems fail to meet the needs of such a Web page author.

FIG. 1 illustrates an existing on-line Asian document publishing system typically found in the application of Web networking. The system includes Web servers at a Web site 21 and client computers at a client site (two client computers 15 and 17 are shown in the figure), which are connected via the Internet 22. The figure shows that a Web page author of the client computer 15 wants to publish an Asian language Web page 30, which includes three Chinese characters 31, 32, and 33, in three different font faces, respectively, and a phrase 34 in a user-defined (non-standard) font face. A browser software 28 is operating on the client computer 15.

Generally, display of an Asian font on a computer screen is based on a font face and a character code. A character code, typically an alphanumeric code, is assigned to each character within a font. Examples of character code sets include JIS code, Shift JIS code, Unicode, and EUC code. When a client computer receives a Web page document including Asian characters, each character is associated with a character code and a font face.

In the present example of FIG. 1, suppose that all of the three font faces, in which the three Chinese characters 31, 32, and 33 are defined, are not supported by the client computer 17. Suppose further that the character codes of the Chinese characters 31 and 33 are supported (i.e., these are standard character codes), but the character code of the Chinese character 32 is not part of any standard character code set and thus cannot be recognized by the client computer 17.

As a result, as illustrated, when viewed by the client computer 17, the computer 17 renders the Chinese characters 31 and 33 in the original Asian language Web page 30 as Chinese characters 36 and 37 on the screen, respectively, in a font face that is substantially different from the font faces of the original characters 31 and 33. This is because the client computer 17 does not support either the font face of the original character 31 or of the original character 33, and thus the browser software 28 operating on the client computer 17 has replaced these unsupported font faces with its default font face. In this example, the client computer 17 at least recognized the character codes for the characters 31 and 33, and therefore was able to display the same characters, albeit in a different font face. As for the character 32 in the original Web page 30, however, the client computer 17 did not even recognize its character code, let alone its font face, and accordingly, the client computer 17 could not display the character 32 at all. Thus, the Chinese character 32 in the original Web page 30 is simply missing in the Web page, as displayed on the client computer 17.

The ideographically expressed Chinese characters in the phrase 34, which were uniquely designed by a user on the client computer 15, graphically mimic the characters' metaphorical meanings understood by most Chinese readers. However, when the Web page 30 is viewed by the client computer 17, its original appearance is lost in the Web page 39 appearing on the screen of the client computer 17. The user-defined font face of the phrase 34 has been replaced with a default font face supported by the client computer 17, and as a result the ideographic expression for semantic connotation intended by the original phrase 34 is completely lost.

In short, because the browser software 28 only recognizes a standard code and an installed font face, some of the characters used to emphasize words or phrases or to express semantic connotation in the original Web page, as designed on one client computer, are lost when viewed and displayed on another client computer.

Therefore, a need exists for a method and mechanism that permits users of client computers to make and edit Asian language documents including multiple font faces, as well as to browse and view the same in their original appearance, without changing the operational configuration of a client computer in a currently existing on-line Asian document publishing system.

### SUMMARY

This summary is provided to introduce a selection of concepts in a simplified form that are further described below in the description of the Preferred Embodiment. This summary is not intended to identify key target features of the claimed subject matter.

In accordance with one embodiment of the present invention, a network-based method is provided for on-line generation of an Asian document with multiple font faces. The method includes generally three steps: (1) providing and connecting a Web font center to an existing network-based Web site; (2) establishing a communication between the Web font center and the Web site for the transmission of font related information; and (3) allowing a client computer connected to the Web site to select one or more multiple font faces for generating (e.g., editing) an Asian Web page document.

In accordance with one aspect of the invention, the Web font center of the present invention consists essentially of five components: a Receiver Program; a Protocol Decoder; a Font Data Retriever; a Provider Program including a Font File Builder and an Output Program; and a Setup Program. The Receiver Program handles users' requests from both Web site and client site. The Receiver Program also includes a firewall scheme for checking the usage rights of a request so that the Web font center can maintain the integrity of its operations. The Protocol Decoder identifies the font-face characters and/or symbols defined in the Web page at a Web site or requested from a client computer, for example, in terms of their font faces and character codes (Unicode/JIS/EUC, etc.). The Font Data Retriever searches a font database to retrieve the font data of the requested font-face characters and/or symbols. The Font File Builder then packs the retrieved font data into a formatted file for delivery. The Output Program sends the packed files to a Web site or a client site. The Setup Program inserts a font face menu into a user-interface screen display program provided by a Web site, so that a user of the Web site's client computer can select and use multiple font faces in generating or editing Asian Web page documents.

In accordance with another aspect of the invention, step (2) of establishing a communication between the Web font center and a Web site for the transmission of font related information involves the insertion of a font face menu into a user-interface screen display program, which is provided by the Web site for its clients to generate or edit Asian Web page documents.

In accordance with another embodiment of the present invention, a network-based system is provided for on-line generation (e.g., editing) of an Asian document with multiple font faces. The system includes generally two elements: (a) a Web font center, connected to an existing Web site, to provide multiple font faces for supporting Asian document publishing with nonstandard font faces; and (b) a Web font supply center connected to the Web font center via a public or private data network, for providing nonstandard font face characters to the Web font center. The Web font center is also connected to, or includes, a Web font database that stores nonstandard font face characters.

In accordance with one aspect of the invention, the Web font center further includes five elements: (i) means for checking the usage rights for the Web font center and for receiving users' requests for nonstandard font faces; (ii) means for decoding font related information communicated between the Web font center and the Web site for identifying the requested font-face characters and/or symbols defined in the Web site; (iii) means for retrieving from the Web font database the font data of the requested font-face characters and/or symbols; (iv) means for packing the retrieved font data into a Web font file for delivery; and (v) means for delivering a font face menu to a Web site.

In accordance with another aspect of the present invention, the means for checking the usage rights for the Web font center checks whether the user is a registered member of an authorized Web site. If a user's rights are confirmed, then the Web font center processes the request. In general, a user's request asks for a (non-standard) font face menu, and in response, the Web font center sends the requested font face menu to be inserted (or installed) into a user-interface screen display program provided by the Web site. Using the font face menu, the users of client computers can make, edit, and view Web font documents with multiple font faces. If the desired font face character cannot be found in the font face menu of the user-interface screen display program, then upon receipt of a further user request the Web font center may download a stroke-based (or glyph-based) font design tool to the client computer so that the user can construct a nonstandard font face character.

In accordance with still another aspect of the present invention, a nonstandard font face constructed based on a stroke-based (or glyph-based) font design tool is then converted to an outline-based font and saved. While a stroke-based (or glyph-based) font, developed by DynaComware Corporation, is suited for high-quality rendering in any display resolution, conventional browser software (or reader software) may support only an outline-based font, and thus the conversion into an outline-based font may be necessary. The construction of a stroke-based (or glyph-based) font, together with various tools for such construction, are described in U.S. Pat. Nos. 5,852,448; 6,151,032; 6,157,390; and 6,501,475, which are incorporated by reference herein, and the conversion between an outline-based font and a stroke-based font is described in U.S. Pat. No. 6,661,417, which is also incorporated by reference herein.

In accordance with a further embodiment of the present invention, a method is provided for generating or editing an Asian document with multiple font faces. The method, in general to be performed at a client computer, involves the following two steps: (i) entering into the browser mode of the user-interface screen display program provided by the Web site to type in text of the document; and (ii) switching to the editing mode to perform: (a) selecting text characters to be replaced with a new font face; (b) selecting (e.g., clicking) a desired font face from a font face menu provided by the Web font center.

In accordance with yet another embodiment of the present invention, the method for generating or editing an Asian document further includes the process of: (iii) storing system font face characters in a background text file and storing non-system (non-standard) font face characters in a foreground text file, after an edited Web page document with multiple font faces has been formed.

In accordance with still another embodiment of the present invention, a method is provided to allow each client computer associated with the Web site to view a Web page document with multiple font faces in its original appearance even if such multiple font faces are not registered with the client computer. The method allows conventional browser software (reader software) to display an Asian document with multiple font faces, and includes generally two procedures. The first procedure allows the browser software to display system font face characters in the background text file, and the second procedure allows the browser software to display non-system (non-standard) font face characters in the foreground text file. The first procedure involves: (1) sending the font related information including the font face(s) and character codes of the characters to be displayed to the client computer; (2) allowing the client computer to access the corresponding font data; and (3) using the font engine installed in the client computer to render the accessed font data and display the system font face characters. The second procedure involves sending a packed Web font file (e.g., foreground text file) including the font data directly to the font engine of the client computer for rendering and displaying.

### DESCRIPTION OF THE DRAWINGS

The foregoing aspects of this invention will bercome more readily appreciated by reference to the following detailed description, when taken in conjunction with the accompanying drawings, wherein:

FIG. 1 illustrates a prior art system for publishing Asian language Web page documents;

FIG. 2 illustrates an overall system for generating or editing an Asian Web page document with multiple font faces and publishing the generated/edited document on a Web site, allowing its clients to view the document in its original appearance;

FIG. 3 is a flowchart illustrating a process to be performed by the components of a Web font center for achieving one goal of the present invention, in accordance with one embodiment of the present invention;

FIG. 4 is a flowchart illustrating a process of the initial setup to be performed by the Web font center, in accordance with one embodiment of the present invention;

FIG. 5A is a flowchart illustrating a process of editing a Web page document on a client computer, in accordance with one embodiment of the present invention;

FIG. 5B is a flowchart illustrating a process of displaying a Web page document on a client computer, in accordance with one embodiment of the present invention;

FIG. 6A is a partial screen view, illustrating a sample Web page document before a user enters into the editing mode of the present invention;

FIG. 6B is a partial screen view, illustrating a process of entering into the editing mode;

FIG. 6C is a partial screen view, illustrating a process of editing the sample Web page document of FIG. 6A with a font face selected from a face font menu;

FIG. 6D is a partial screen view, illustrating a new appearance of the sample Web page document of FIG. 6C after it has been edited;

FIG. 7A illustrates the sample Web page document of FIG. 6A in a HTML file;

FIG. 7B illustrates the resultant Web page document of FIG. 6D in a HTML file;

FIG. 8 schematically illustrates various concepts used to generate a stroke-based (or glyph-based) font based on explicit and implicit parameters, in accordance with one embodiment of the present invention;

FIG. 9A is a flowchart illustrating an automatic conversion algorithm for converting a stroke-based font to an outline-based font, in accordance with one embodiment of the present invention; and

FIG. 9B illustrates several steps of converting stroke-based font data to outline font data, in accordance with one embodiment of the present invention.

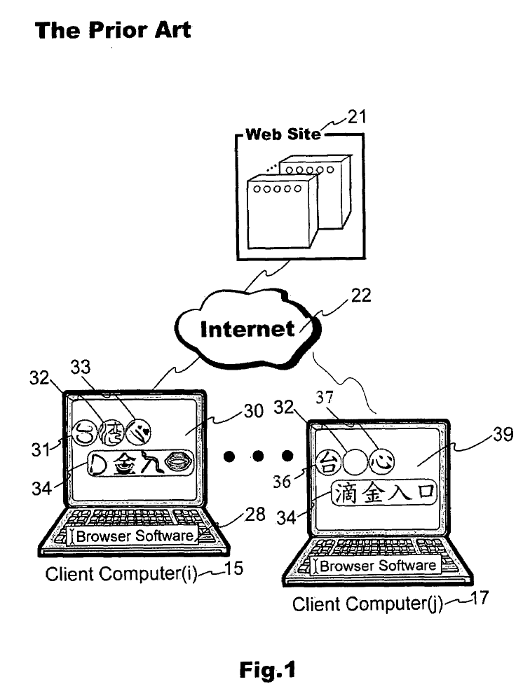

### DETAILED DESCRIPTION

According to a method and system of the present invention, a Web font center is connected to an existing Web page publishing system, to add to the system the capability of allowing client users to generate or edit an Asian Web page document including multiple font faces and to view the same in its original appearance. As will be revealed in the following exemplary embodiments, the invention achieves this goal by replacing conventional font data of an Asian Web page document with outline-based “Web font data” that can be accessed and properly displayed by conventional browser software. Specifically, the invention provides a system and method of allowing a user of a client computer to generate or edit an Asian Web page document with multiple font faces, which may not be registered or supported in the client computer.

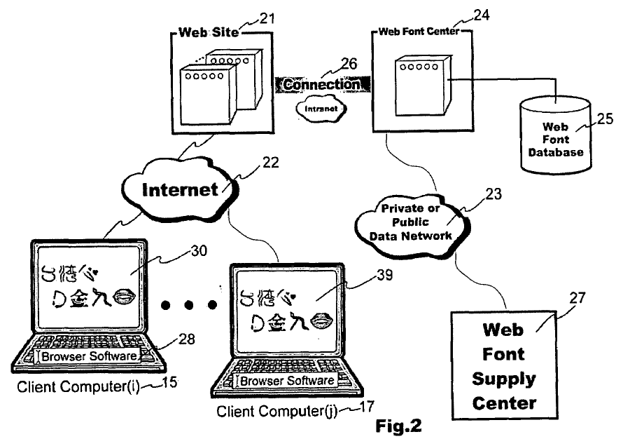

FIG. 2 illustrates an overall system for allowing client computer users to generate or edit an Asian Web page document with multiple font faces and to display the generated/edited Web page document with multiple font faces, according to one embodiment of the present invention. As illustrated in the figure, the system includes a Web site 21 supporting publication of an Asian language Web page 30 made in a client computer (i) 15 and displayed on a client computer (j) 17, both of which are operating browser software 28 thereon. The system further includes a Web font center 24 connected to the Web site 21. The Web font center 24 and the Web site 21 together provide for making an Asian language Web page document with multiple font faces and displaying the same in its original appearance. The Web font center 24 includes or is coupled to a Web font database 25, which stores Web font data of multiple font faces. The Web font center 24 is also connected to a Web font supply center 27, which is provided for supplying Web font data not existing in the Web font database 25.

In the illustrated embodiment, the Web font center 24 is connected to the Web site 21 via an intranet or a direct connection 26, and to the Web font supply center via a public (or private) data network 23. A client computer is connected to the Web site 21 via the Internet. The connection of a client computer to the Web site 21 is by assigning the Internet Protocol (IP) address of the Web site into the browser software 28 of the client computer. The connection of the Web font center 24 to the Web site 21 is by assigning an Internet Protocol (IP) address of the Web font center 24 into the socket function of a Web page file supported at the Web site 21 for calling TCP/IP (Transmission Control Protocol/Intranet Protocol).

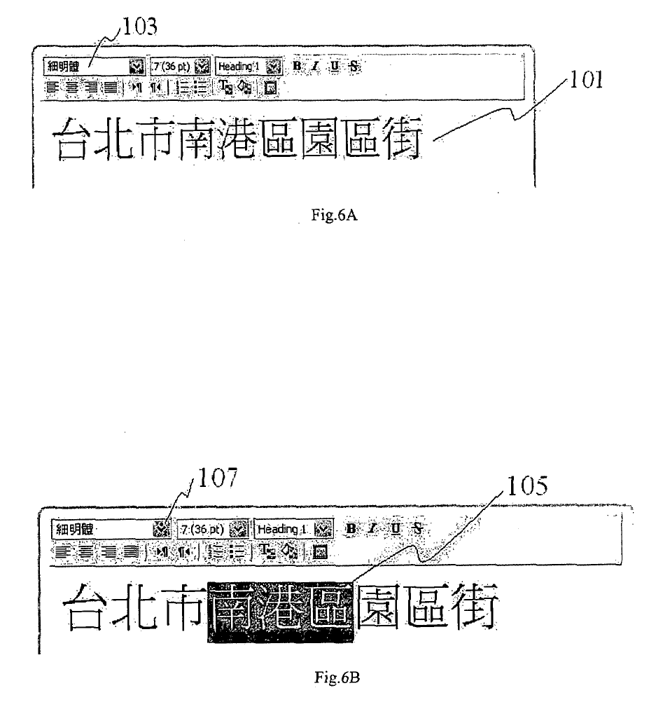

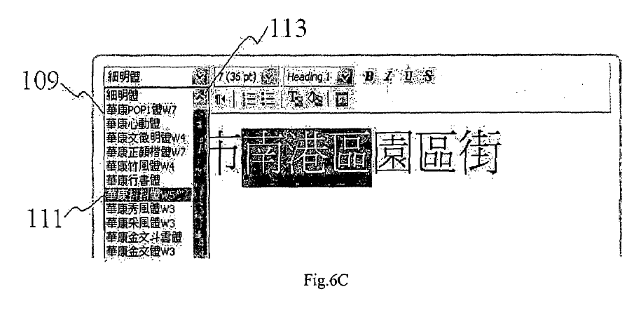

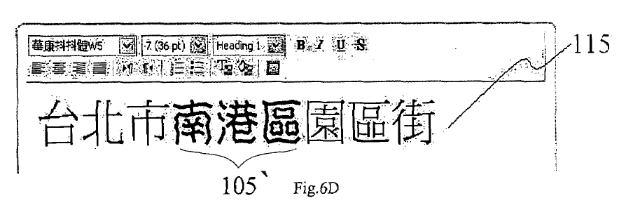

When a client computer activates its browser software 28 and accesses the Web site 21 for making or editing Web page documents, the Web site 21 downloads its user-interface screen display program onto the browser software 28 via the Internet. In accordance with various exemplary embodiments of the present invention, the user-interface screen display program allows display of a font face menu (see FIG. 6C, 109) on the client computer, which lists multiple font faces available for the user in generating/editing Web page documents. The user types in or selects characters in a document via an input device (e.g., a keyboard, mouse, etc.) and selects a desired font face for the characters from the font face menu. The browser software 28 then displays the characters in the selected font face (according to a conventional procedure) if the selected font face is registered in the client computer. If the selected font face is not registered in the client computer, then the browser software 28 receives a Web font file (for the selected font face) from the Web font center 24 and sends the font file including necessary font data directly to the font engine installed in the client computer. The font engine then renders and displays the characters in the unregistered font face on the client computer.

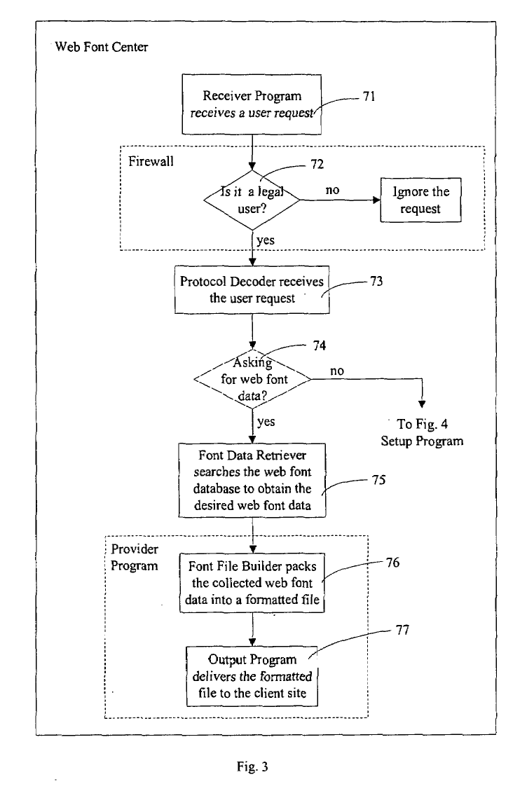

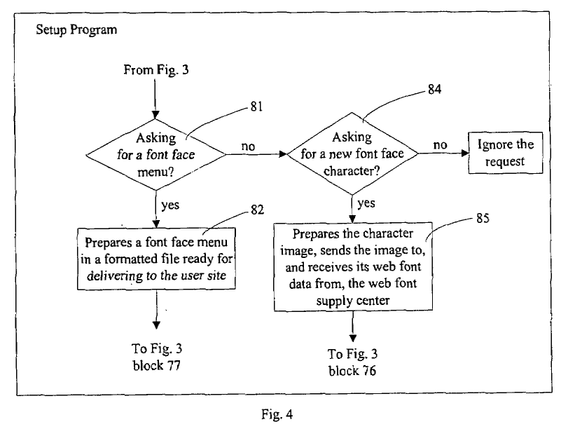

In accordance with one embodiment of the present invention, a Web font center 24 essentially includes five components. The first component is a Receiver Program including a firewall scheme to protect the Web font center 24 against an intruder or illegal user. As shown in FIG. 3 block 71, the Receiver Program receives a user request and, as shown in block 72, if the firewall scheme finds that a request is from a licensed (legal) user (based on the user's ID and/or password, for example) then it accepts the request, else it ignores the request. As shown in block 73, the Receiver Program sends a legal request to the second component, a Protocol Decoder. As shown in block 74, in one embodiment, the Protocol Decoder then determines whether the received user request is asking for Web font data for generating or editing text. If so, the Protocol Decoder decodes the user request to identify the requested font related information including, for example, character code and font face for each character/symbol entered/selected by the user, and passes the font related information to the third component, a Font Data Retriever. As shown in block 75, the Font Data Retriever searches the Web font database 25 (FIG. 2) to obtain the Web font data corresponding to the font related information. The obtained Web font data will be sent to the fourth component, a Provider Program. The Provider Program includes a Font File Builder and an Output Program. As shown in block 76, the Font File Builder packs the retrieved Web font data into a formatted file (a Web font file), and as shown in block 77, the Output Program delivers the formatted file to the Web site 21 or to any of the client sites.

Returning to block 74, if it is determined that the received user request is not asking for Web font data, then the fifth component, a Setup Program, is called according to various exemplary embodiments of the present invention. The Setup Program inserts a font face menu into the user-interface screen display program provided by the Web site 21, so that a user of the Web site's client computer can select and use multiple font faces in generating or editing Asian Web page documents.

FIG. 4 is a flowchart illustrating a sample process to be performed by the Setup Program. As shown in the figure, there are generally two procedures in the process. In block 81, the Setup Program begins its process by checking if a user's request (from a Web site) is asking for a new font face menu. If so, as shown in block 82, the Setup Program prepares a font face menu (in a formatted file) for the Web site. The font face menu lists multiple font faces available for the user to generate/edit a Web page document. The Web site 21 receives the font face menu from the Web font center 24 and embeds the font face menu into its user-interface screen display program so that the browser software 28 operating on a client computer can utilize the font face menu. Specifically, a user of the client computer on which the browser software 28 is operating can generate/edit Asian documents with multiple font faces listed in the font face menu, even if these font faces are not registered in the client computer.

As shown in FIG. 4, block 84, if it is determined that the user's request is asking for a new font face character that cannot be found in the Web font database 25 (FIG. 2), then, as shown in block 85, the second procedure of the Setup Program is activated. The second procedure involves construction of the desired character image on the client computer, and construction of the associated Web font data of the character image in the Web font supply center 27. In one possible arrangement, the Web font center 24 downloads a stroke-based (or glyph-based) font construction tool for a client computer user to construct a desired character image with multiple strokes (or glyphs) selected from various fonts. The Web font center 24 receives from the client computer the resulting stroke-based (or glyph-based) font data constructed on the client computer, and sends the stroke-based (or glyph-based) font data to the Web font supply center 27. The Web font supply center 27 converts the stroke-based (or glyph-based) font data into outline-based Web font data. As shown in the figure, the outline-based Web font data will be sent to the Font File Builder, which packs the Web font data into a formatted file. (FIG. 3, block 76) Then, the Output Program delivers the formatted file to the client computer for displaying the constructed font face character properly in a Web page document via the browser software 28.

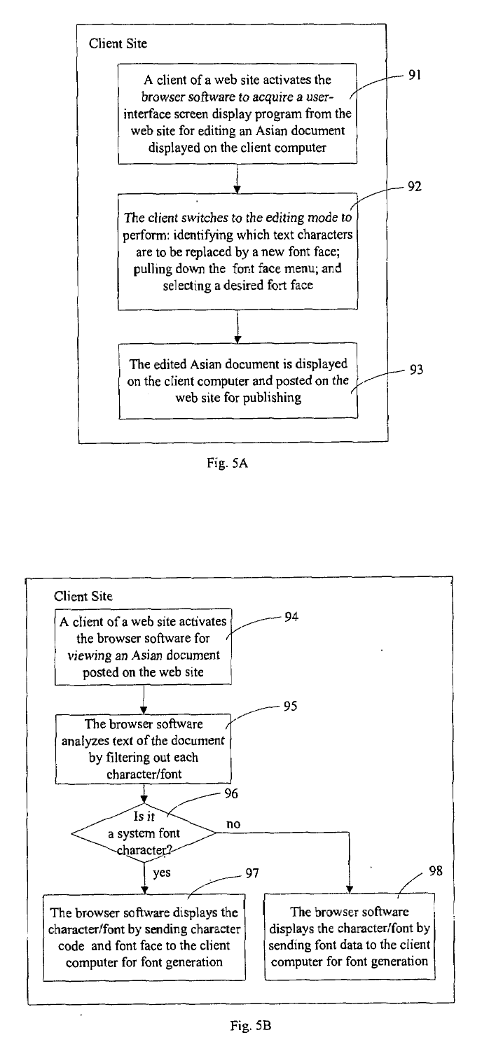

FIGS. 5A and 5B are flowcharts illustrating exemplary steps to be performed generally by the browser software 28 (FIG. 2) operating on a client computer for generating or editing (FIG. 5A) or displaying (FIG. 5B) Asian Web font documents with multiple font faces, which may or may not be registered in the client computer. FIGS. 6A-6D are partial screen views on the client computer resulting from the steps shown in FIGS. 5A and 5B.

FIG. 5A shows a flowchart illustrating the operational steps associated with the browser software 28 for generating or editing an Asian Web page document posted or will be posted on a Web site with new font faces, according to one embodiment of the present invention. At block 91, a user of a client computer of a Web site activates the computer's browser software 28 (FIG. 2) to acquire a user-interface screen display program provided by the Web site for editing an Asian document displayed on the computer screen. The Asian document may be obtained from the Web site or the client computer. For example, FIG. 6A, label 101 illustrates text of nine Asian characters in a font face 103.

At block 92 of FIG. 5A, the user switches to the editing mode. For example, when the user of the client computer clicks the icon labeled 107 in FIG. 6B, the user-interface screen display program is switched to an editing mode. In the editing mode, the user selects characters to be replaced with new font-face characters, for example, by highlighting those characters. In the example of FIG. 6B, three characters labeled 105 are selected to be replaced with the same characters but in a new font face not registered in the client computer.

Also in the editing mode, as shown in FIG. 6C, the user pulls down a font face menu 109 listing multiple font faces, which are provided by the Web font center 24 and are available for selection. As shown in FIG. 6C, a scroll bar 113 may be provided to accompany the font face menu 109 to include as many as possible font faces for generating or editing an Asian Web page document. Referring additionally back to block 92 of FIG. 5A, after identifying the characters to be replaced with new font-face characters and pulling down the font face menu, the user clicks to select a new font face 111 in the font face menu 109 in FIG. 6C.

Then, in block 93, FIG. 5A, the generated or edited Asian documents with new font face(s) are displayed on the client computer, and then posted on the Web site 21 for publishing. In one embodiment, the user's selection of the new font face 111 brings about a screen view shown in FIG. 6D, in which the three selected characters (105 in FIG. 6B) have been replaced with characters 105′ in the new font face 111. Also, a generated or edited Asian Web page document with new font face(s) replaces the original document, and the browser software 28 sends the generated or edited Asian Web page document to the Web site 21 for publication.

FIG. 5B is a flowchart illustrating the operational steps to be performed at a client site for viewing an Asian Web page document posted on a Web site, according to one embodiment of the present invention. At block 94, a user of a client computer of a Web site activates the computer's browser software 28 for browsing Web page documents. When an Asian Web page is browsed, as shown in block 95, the browser software 28 receives, in general, an HTML file associated with the Web page and analyzes (interprets) the received HTML file by filtering out each character code and each font face specified in the HTML file. The browser software 28 then displays text of the document on the client computer screen.

In accordance with various exemplary embodiments of the present invention, an HTML file generated or edited by a method according to the present invention combines two text files: one is a background text file for the browser software 28 to display system (standard) font characters, and the other is a foreground text file for the browser software 28 to display non-system (non-standard) font characters. At block 96, the browser software 28 determines if a character is a system font character, i.e., a font-face character that has been registered in the client computer. If so, at block 97, the browser software 28 interprets the background text file to display the system font. Specifically, the browser software 28 sends the character code and font face (name) of the character to the client computer. The client computer then uses the received character code and font face to access the corresponding font data. Then, a font engine installed in the client computer renders the accessed font data and displays the character on the client computer screen via the browser software 28.

If, on the other hand, it is determined at block 96 that the particular character is not a system font character, at block 98, the browser software 28 interprets the foreground text file for displaying non-system (non-standard) font characters. Specifically, the browser software 28 receives and sends the non-standard font data as expressed in the HTML file (generated according to a process of FIG. 5A, for example) directly to the client computer's font engine to render and display the non-standard character/font.

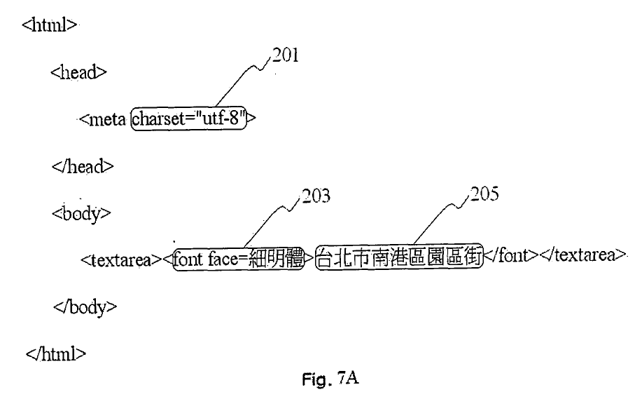

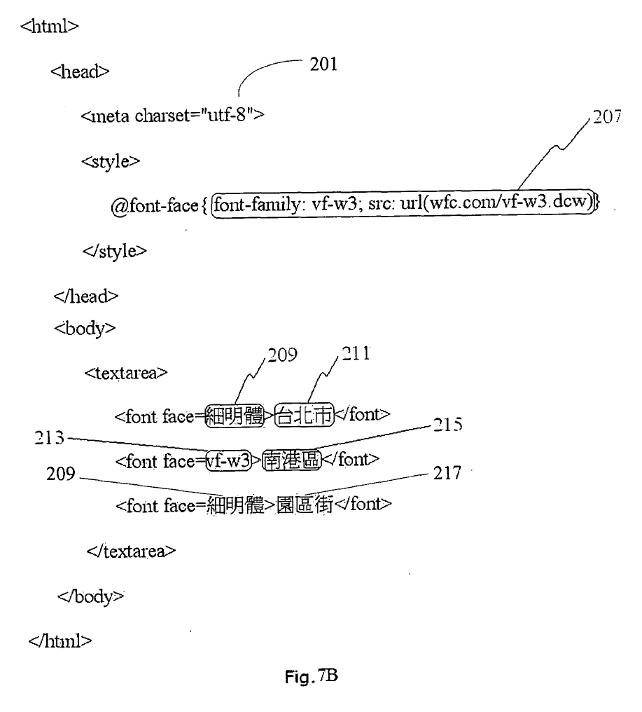

FIG. 7A shows a character/font related portion of the HTML file associated with the system font characters shown in FIG. 6A. A file header (of the HTML file) 201 may indicate where or how to access the specified system font face 103 (FIG. 6A) and the displayed characters 101 (FIG. 6A). The file body of the HTML file may contain the font related information as defined in the file header. Specifically, the font related information 203 may indicate the font face 103 and the font related information 205 may indicate the content of the characters 101 as defined by their character codes. The browser software 28 sends the character codes and font face to the client computer, which accesses the font data based on the character codes and font face, and sends the font data to the font engine of the client computer. The font engine then renders the font data to display the characters 101 in a proper text area.

FIG. 7B shows an HTML file associated with the document shown in FIG. 6D. The selected font face 111 (FIG. 6C) for the selected characters 105 (FIG. 6B) is now referred to in a file header 207 indicating where to find its corresponding font data, such as its URL address. The HTML file shown in FIG. 7B can be regarded as a combination of two text files: one is a background text file and the other is a foreground text file. The background text file is used by the browser software 28 to display the system font characters and the foreground text file is used by the browser software 28 to display the generated or edited non-system (non-standard) font characters. As shown in FIG. 7B, the background text file is expressed as a combination of the file header 201, and a file font face (name) 209 and character codes 211, 217 in the file body. The foreground text file is expressed as a combination of the file header 207, and a font face (name) 213 and Web font data 215 in the file body. The font data 215 is, in general, expressed in an outline font format, because the conventional browser software 28 can only interpret font data in an outline font format. The browser software 28 interprets the foreground text and then sends the font data 215 directly to the font engine installed in a client computer to display the new font-face characters 105′ (FIG. 6D) on the computer screen.

In one embodiment of the present invention, the Web font data may be defined using a glyph-based or stroke-based method, many examples of which are disclosed in U.S. Pat. Nos. 5,852,448; 6,151,032; 6,157,390; and 6,501,475, which are all incorporated by reference herein. In order for the conventional browser software 28 to recognize font data, stroke-based (or glyph-based) font data must be converted to an outline font format that can be rendered by the font engine of a client computer on which the conventional browser software is operating. To that end, according to one embodiment of the present invention, the Web font supply center 27 (FIG. 2) constructs (or receives) a non-standard font face character based on a stroke-based (or glyph-based) method because the stroke-based (or glyph-based) method is suitable for constructing high quality Asian font, and then automatically converts the resulting font into an outline font format. As shown in FIG. 2, in various exemplary embodiments of the present invention, the Web font supply center 27 supplies all Web font data in an outline font format to the Web font center 24 to be stored in the Web font database 25. The Web font center 24 constructs an HTML file ( as shown in FIG. 7B) by combining a foreground text file with an original background text file, wherein the font data in the foreground text file is in an outline font format as supplied by the Web font supply center 27.

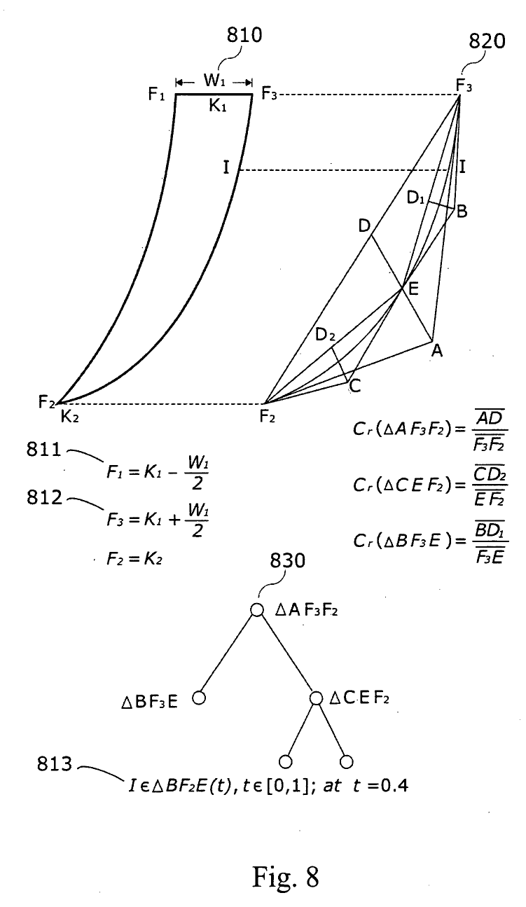

FIG. 8 illustrates various concepts used in a stroke-based method for defining a stroke and how a point on the stroke contour is determined based on the stroke definition. As illustrated, any stroke 810 that forms part of a character may be defined in terms of function ƒ(K,W,F,Cr), where K denotes a “key point” (K₁ and K₂ are shown), W denotes a “width value” (W₁ is shown), F denotes a “feature point” (F₁, F₂, and F₃ are shown), and Cᵣ denotes a “curve ratio” (ΔAF₃F₂, ΔCEF₂, and ΔBF₃E are shown). The key points and width values are explicit parameters that are used to define the shape of a stroke. The feature points and curve ratios are implicit parameters that can be derived from the explicit parameters. For example, in the illustrated example of FIG. 8, feature points F₁ and F₃ can be calculated based on the equations 811 and 812, respectively, by plugging the key points (K₁ and K₂) and width value (W₁) into the equations. Further, once the positions of the feature points are determined, then the curve between each adjacent pair of the feature points can be determined using the curve ratios arranged in a binary tree structure 830.

Specifically, the binary tree structure 830 is built up according to the shape between two adjacent feature points. For example, as shown in FIG. 8, 830 is obtained from arranging a subdivision of the curve 820 (between F₃ and F₂) according to multiple levels of resolution. The binary tree structure 830 thus obtained defines curve segments between F₃ and F₂, wherein each curve segment is determined by a Bezier triangle and each triangle can be determined by its associated curve ratio. For example, for ΔAF₃F₂ with a base of the line segment F̅₃̅F̅₂̅ and a vertex A, the curve ratio Cᵣ associated with this Bezier triangle is defined as the ratio between the center line length (i.e., the length of the line connecting the vertex and the middle point of the base of the Bezier triangle) and the length of the base. ΔBF₃E similarly defines a curve segment between F₃ and E, and ΔCEF₂ defines the curve segment between E and F₂. A combination of these two curve segments is closer to an ideal curve shape than the previous curve segment (ΔAF₃F₂). In this way, the curve segments in a binary tree can be defined at a higher level of resolution with deeper subdivision.

The location of a point on the contour of a stroke can be determined by knowing the Bezier triangle on which the point falls. For example, a point I on the contour of the stroke 810 falls in the Bezier triangle ΔBF₃E, which defines a Bezier curve ΔBF₃E(t) 831, where tε[0,1] (See, FIG. 8). As illustrated in the figure, the point I is located on the Bezier curve 831 at t=0.4. Similarly, an intersection point of two strokes can be determined by knowing both of the Bezier triangles that contain the intersection point in their respective binary tree structures.

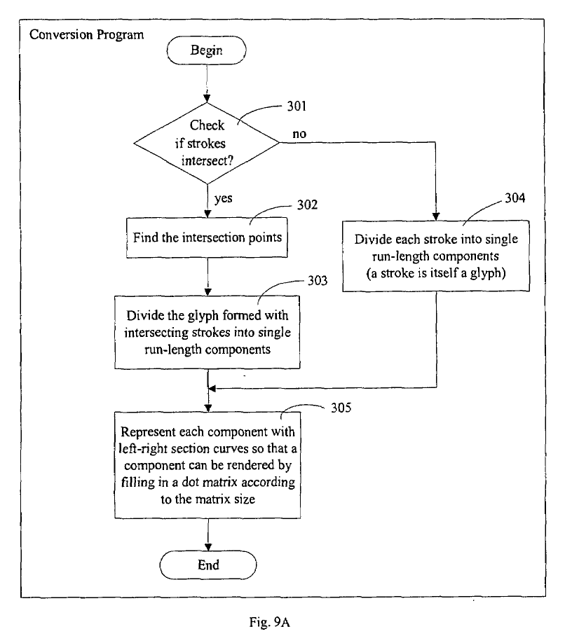

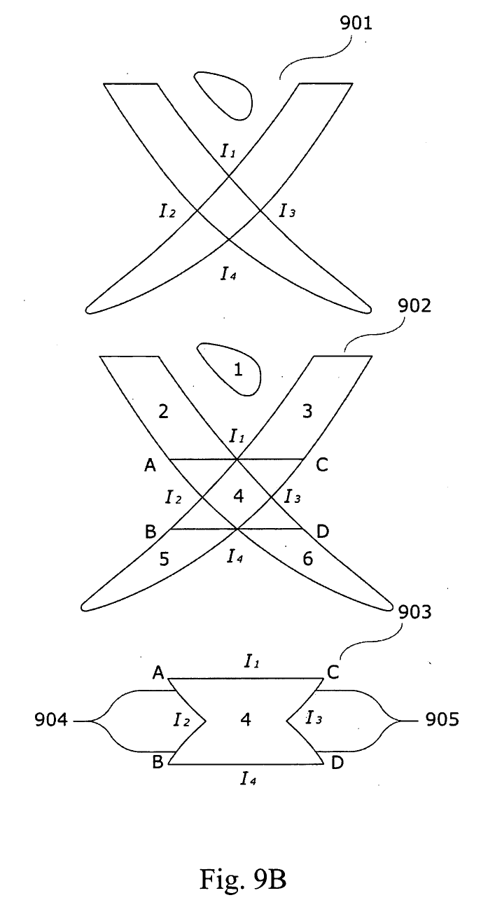

FIG. 9A is a flowchart illustrating exemplary steps to be performed in a conversion program installed in the Web font supply center 27 (FIG. 2) for converting a stroke-based font to an outline font. At step 301, the conversion program determines if strokes intersect with each other. For example, the character 901 shown in FIG. 9B is formed with three strokes, and two of them intersect with each other. At step 302, the intersection points I₁, I₂, I₃, and I₄ (FIG. 9B) are found. At step 303, the glyph (or the basic unit of a character) formed by intersecting strokes is divided into single run-length (or single scan-length) components, such as the components 2, 3, 4, 5, and 6, in 902 of FIG. 9B. Referring back to step 301, if it is determined that no two strokes are intersecting, it is presumed that a stroke itself is a glyph. Then, in block 304, the stroke itself is divided into single run-length components, such as the component 1 in 902 of FIG. 9B. At step 305, the conversion program generates the outline font data of a character 901 as a collection of single run-length components, with each single run-length component being represented by a pair of left and right section curves. As shown by the component 903 in FIG. 9B (corresponding to the component 4 in 902), left and right section curves 904 and 905 of the component 903 formed by intersecting strokes may consist of Bezier curve segments of the intersecting strokes. Other components, such as 1, 2, 3, 5, and 6 in 902, each has left and right section curves from the same stroke. A conventional font engine found in a client computer can readily render each single run-length component by filling it into a dot matrix according to its assigned size.

Numerous variations in the illustrated and described arrangements of systems, components, and sequences of operations will be apparent to one skilled in the art based on this disclosure. Various aspects of the invention may be used separately, or in combinations, or in sequences other than those explicitly disclosed. Thus, it will be appreciated that various changes can be made therein without departing from the spirit and scope of the invention.

The embodiments of the invention in which an exclusive property or privilege is claimed are defined as follows:

1. A network-based method for generating or editing an Asian document with multiple font faces, wherein the multiple font faces not registered in a client computer are supplied by a Web font center, the method comprising the steps of:
(a) providing and connecting a Web font center to a Web site system for Asian Web page document publishing;
(b) establishing communication between the Web font center and the Web site for transmission of font related information therebetween; and
(c) allowing a client computer of the Web site to make, edit, and view an Asian Web page document with multiple font faces not registered in the client computer.

2. The network-based method of claim 1, wherein connecting a Web font center to a Web site comprises assigning an Internet Protocol (IP) address of the Web font center into a socket function of a Web page program at the Web site for calling TCP/IP (Transmission Control Protocol/Internet Protocol).

3. The network-based method of claim 1, wherein the font related information transmitted between the Web font center and the Web site includes a font face name and character code.

4. The network-based method of claim 1, wherein step (b) further comprises: (i) sending from the Web font center a font face menu to the Web site; and (ii) inserting the font face menu into the user-interface screen display program provided by the Web site, and step (c) further comprises displaying the font face menu on the client computer based on browser software operating on the client computer.

5. The network-based method of claim 1, wherein step (c) comprises: (i) receiving a request from browser software of a client computer, wherein the request indicates a user's intent to generate or edit font-face characters in text of a document; (ii) sending font data for the font-face characters in a formatted file to the client computer; and (iii) displaying the generated or edited font-face characters on the client computer based on the browser software.

6. The network-based method of claim 5, wherein the formatted file includes a background text file for displaying system font and a foreground text file for displaying non-system font.

7. The network-based method of claim 6, wherein font data for the system font are accessed based on font face name(s) and character codes and the accessed font data for the system font are sent to a font engine of the client computer, while font data for the non-system font are sent directly from the Web font center to the font engine of the client computer.

8. A computer-readable medium having computer executable instructions to perform the steps recited in claim 1.

9. An apparatus to be connected to an existing Web site system for publishing Asian Web page documents, the apparatus allowing a client computer of a Web site to make, edit, and view an Asian document with multiple font faces not registered in the client computer, the apparatus comprising:
i. a Receiver Program that includes a firewall scheme to protect illegal intrusion into the apparatus, the Receiver Program receiving users' requests;
ii. a Protocol Decoder that identifies font faces and character codes of characters to be generated or edited;
iii. a Font Data Retriever that searches a Web font database to retrieve desired Web font data;
iv. a Provider Program that includes a Font File Builder to pack the retrieved Web font data into a formatted file, and an Output Program to deliver the formatted file to the Web site; and
v. a Setup Program that installs a font face menu into a user-interface screen display program provided by the Web site.

10. A network-based system for generating or editing a Web font document with multiple font faces not registered in a client computer, the system comprising a Web font center connected to an existing Web site system for publishing Asian Web page documents, the Web font center further comprises:
i. a Web font database that stores Web font data;
ii. means for checking a user's usage rights to access the Web font center;
iii. means for receiving users' requests;
iv. means for decoding font related information communicated between the Web site and the Web font center;
v. means for retrieving from the Web font database Web font data; and
vi. means for packing the retrieved Web font data into a Web font file for delivery to the Web site.

11. The network-based system of claim 10, wherein the connection of the Web font center to the Web site comprises assigning an Internet Protocol (IP) address of the Web font center into a socket function of a Web page program at the Web site for calling TCP/IP (Transmission Control Protocol/Internet Protocol).

12. The network-based system of claim 10, wherein the means for checking a user's usage rights further comprises:
(a) means for checking the user's ID and/or passwords;
(b) means for accepting a request from a legal user and rejecting a request from an illegal user; and
(c) means for sending a font face menu to be inserted into a user-interface screen display program provided by the Web site.

13. The network-based system of claim 10, wherein the means for receiving users' requests further comprises:
(a) receiving a user-defined non-standard font character;
(b) sending the user-defined non-standard font character to a Web font supply center;
(c) converting the user-defined non-standard font character into Web font data at the Web font supply center;
(d) receiving the Web font data from the Web font supply center; and
(e) packing the Web font data into a HTML file that can be interpreted and displayed by browser software operating on the client computer.

14. The network-based system of claim 13, wherein the user-defined font non-standard character is defined as a stroke-based or glyph-based character, and the means for converting the user-defined non-standard font character converts the stroke-based or glyph-based character into an outline-based font character.

15. The network-based system of claim 10, wherein the means for decoding font related information communicated between the Web site and the Web font center further comprises:
means for recognizing font faces and character codes.

16. A method for on-line generation or editing of an Asian Web page document with multiple font faces not registered in a client computer, the method comprising the steps of:
i. entering into an editing mode of a user-interface screen display program provided by a Web site;
ii. selecting text characters to be replaced with characters in a new font face;
iii. selecting the new font face from a font face menu provided by the user-interface screen display program; and
iv. displaying the Asian Web page document with the selected text characters replaced with characters in the selected new font face.

17. The method of claim 16, further comprising a step of storing the Asian Web page document by:
(a) storing system font characters of the document in a background text file; and
(b) storing non-system font characters of the document in a foreground text file.

18. The method of claim 17, wherein the Asian Web page document is stored as an HTML file.

19. The method of claim 17, wherein the step of displaying the Asian Web page document further comprises:
(a) rendering a character in the background text file based on a font engine of the client computer; and
(b) rendering a character in the foreground text file by sending the stored non-system font characters directly to a font engine of the client computer.

20. A computer-readable medium having computer executable instructions to perform the steps recited in claim 16.
